(19) United States
(12) Patent Application Publication
(10) Pub. No.: US 2024/0383465 A1
(43) Pub. Date: Nov. 21, 2024

(54) METHOD FOR IDENTIFYING AND CHARACTERIZING, BY USING ARTIFICIAL INTELLIGENCE, NOISES GENERATED BY A VEHICLE BRAKING SYSTEM

(71) Applicant: Brembo S.p.A., Curno, Bergamo (IT)

(72) Inventors: Danilo BENETTI, Curno, Bergamo (IT); Elena MAZZOLENI, Curno, Bergamo (IT); Micael RESCATI, Curno, Bergamo (IT); Pietro Andrea GRILLI, Curno, Bergamo (IT); Cristian MALMASSARI, Curno, Bergamo (IT); Andrea CERUTTI, Curno, Bergamo (IT)

(21) Appl. No.: 18/696,414

(22) PCT Filed: Sep. 28, 2022
(86) PCT No.: PCT/IB2022/059229

§ 371 Date: Mar. 28, 2024

(30) Foreign Application Priority Data
Sep. 30, 2021 (IT) 102021000025013

(51) Int. Cl. B60T 17/22; G01H 17/00; G06N 20/00; G07C 5/08

(52) U.S. Cl. CPC B60T 17/221; G01H 17/00; G06N 20/00; G07C 5/0808; G07C 5/0816

(57) ABSTRACT

A method for identifying and characterizing noises generated by a vehicle braking system is described. The method first comprises the steps of detecting noises generated by a vehicle braking system under dynamic operating conditions and generating digital audio data representative of the detected noise. The method then provides analyzing the aforesaid digital audio data by a noise analyzer, to identify potential squeal events and respective likely squeal frequencies, and generating squeal frequency information indicative of the squeal frequencies of the identified potential squeal events. The method then comprises the steps of filtering the aforesaid digital audio data by means of high-pass filtering to eliminate spectral components at frequencies lower than a filtering frequency, to generate filtered digital audio data; and generating, based on the filtered digital audio data, a respective spectrogram, which represents, in graphical form, information present in the filtered digital audio data, comprising the sound signal intensity, as a function of time and frequency. The method then involves providing the aforesaid spectrogram and the aforesaid squeal frequency information to a trained algorithm, wherein the algorithm was trained using artificial intelligence and/or machine learning techniques. The method also provides identifying noise events, by the trained algorithm, based on the above spectrogram and squeal frequency information, classifying the identified noise events and finally providing information about the identified noise events, each characterized by the respective category. The aforesaid classification step involves a classification according to at least the following categories: a first category comprising noises to be detected generated by the characteristic dynamic operation of the braking system; and a second category comprising abnormal noises, generated by operational or test anomalies.

### TECHNOLOGICAL BACKGROUND OF THE INVENTION

### Field of Application

The present invention refers to a method for identifying and characterizing, through the use of artificial intelligence (AI), noises generated by a vehicle braking system.

The present invention also relates to a method based on artificial intelligence (AI) for analyzing the noise produced during dynamometric testing of automotive brake systems.

### Description of the Prior Art

Nowadays, ride comfort is one of the critical aspects in evaluating a vehicle.

In particular, in the automotive industry, customer complaints regarding so-called NVH (noise, vibration, harshness) aspects related to the brake system are a serious problem.

For this reason, it is essential to understand, starting from the design phase of a braking system, the phenomena related to the generation of undesired vibration and noise, to prevent them from happening.

Since the physics of friction-induced vibrations (FIV) is very complex and characterized by highly nonlinear and multiscale phenomena, there are no analytical mathematical theories capable of comprehensively predicting the behavior of a system regarding the above.

Therefore, much of the research and analysis in this field, in both industrial and non-industrial environments, is conducted experimentally. A large amount of data is collected by testing the braking system under controlled conditions and recording its response as input parameters change.

To measure noise generation during the development stages, braking systems are tested on a dynamometric (or roller stand) test bench, in which a predefined braking sequence is applied.

The noise is measured during a test usually employing a noise analyzer installed on the test bench. A standard noise analyzer identifies noise events based on amplitude criteria and known Fourier transform-based spectral processing methods. This implies that such noise analyzers are designed to recognize “tonal noise”, i.e., events characterized by very narrow frequency bands. An example of tonal noise is squeal, i.e., a type of noise characterized by a spectrum with a narrow frequency band and a very high amplitude relative to the background (typically with an intensity more than 50 dB greater than the background).

The noise analyzer typically generates as a result a file containing information about the squeals it has identified (braking event number, presence or absence of squeals, time markers, frequency, sound pressure, duration, and so on).

However, due to the possible simultaneous presence of several different FIV phenomena, other types of noise may also be produced during a test, among which we can mention for example:
collision noise (also called “clang”), i.e., an instantaneous pulse covering a wide range of frequencies caused by collision phenomena between components;
chirp/wirebrush, i.e., many short pulses of noise at different frequencies;
artifacts, i.e., noise events with a wide frequency band and high intensity.

Known noise analyzers recognize these types of noise (whose spectral characteristics differ significantly from those of squeals) with difficulty, or unreliably, and on the other hand sometimes mistakenly identify other types of noise as squeals.

Furthermore, the effectiveness of the detection and classification achievable by a noise analyzer is severely limited by the noise inherent in the test environment itself. This situation can lead to the detection of both false positives (FP), i.e., squeals detected when in fact there are none, and false negatives (FN), i.e., squeals that occur but are not detected.

While it is well known that the output of a noise analyzer is only partially reliable, it is known on the other hand that engineers experienced in noise and vibration can classify the different types of noise based on a spectrogram generated from sound measurements.

A spectrogram is a diagram in which noise data (measured frequency, time of occurrence, and sound intensity) are translated into an image.

Thus, the possibility is known to transform audio tracks into spectrograms that contain an equivalent level of information.

Based on this, methods have been suggested to interpret the information in a spectrogram using machine learning (ML) algorithms.

These techniques employ training techniques which start from known data available in the form of spectrograms, in which known noise events are highlighted, with each of which information about the known type of noise is associated.

Despite the progress in this field, including the application of ML algorithms for the interpretation of spectrograms, many unsolved problems and unmet needs remain, given the technical complexity of the problem, in particular the difficulty in detecting, recognizing, and discriminating the vast plurality of noises that can actually be generated due to many different causes.

Firstly, it must be noted that the distinction between different noise classes is not always clear, even to an expert in the field. For example, it can be difficult to discriminate a chirp from a series of very short little squeals even by applying an ML algorithm on a spectrogram. Even a squeal at a certain frequency does not necessarily have a constant intensity, and this results in a change of color on the spectrogram. When a squeal has a consistent variation in intensity, it becomes difficult to understand visually whether it is a single event or several distinct events, separate from each other, which follow one another rapidly.

In the aforesaid known solutions, single-frequency squeals are always classified as single events, regardless of intensity modulation, which can lead to incorrect assessments.

Additionally, on a spectrogram, the fundamental frequency of a squeal may be accompanied by higher-order harmonics, i.e., noise events similar to the original squeal in terms of shape on the spectrogram and appear at multiple frequencies of the fundamental frequency of squeal, with decreasing intensities. The known noise analyzers often incorrectly classify such higher-order harmonics as if they were independent squeals when they should be discriminated and excluded from the analysis, and preferably recognized and classified as a separate category.

Furthermore, another issue not addressed by known methods, yet critical when testing, is the treatment of low-frequency (<500 Hz) noise events. Indeed, it is within the norm for a spectrogram to exhibit low-frequency noise, often very intense, attributable to the test environment.

As the color scale of the spectrogram is normalized to the maximum and minimum intensities detected in the time interval analyzed, i.e., it is a relative scale, low-frequency noise events can distort the color scale, thus attenuating the visualization of events of interest at higher frequencies, and decreasing the effectiveness of the noise recognition and classification algorithm.

Finally, another important aspect not addressed in known solutions (even those employing ML algorithms) relates to the recognition of noise categories indicating anomalies. In particular, an anomaly may relate to a poor experimental arrangement (e.g., inaccurate installation of certain elements on the dynamometric bench) or a poor design of the brake system (e.g., pads hitting the brake caliper during a braking action). On the other hand, it would be very desirable to be able to recognize and classify noises associated with anomalies, e.g., to generate appropriate anomaly warning signals during the test.

Thus, as shown above, many unmet needs remain in the area of recognition and classification of noise generated by a braking system, to which the solutions known to date do not provide fully satisfactory solutions.

### SUMMARY OF THE INVENTION

The present invention, therefore, relates to a method based on artificial intelligence (AI) for improving the quality of the analysis noise produced during dynamometric testing of automotive brake systems.

In particular, it is the object of the present invention to provide a method for identifying and characterizing, by using artificial intelligence, of characterizing noises generated by a vehicle braking system, which makes it possible to solve, at least in part, the drawbacks described above with reference to the prior art and to respond to the aforesaid needs particularly felt in the considered technical sector. Said object is achieved by a method according to claim 1.

Further embodiments of such a method are defined in claims 2-24.

### BRIEF DESCRIPTION OF THE DRAWINGS

Further features and advantages of the method according to the invention will become apparent from the following description of preferred exemplary embodiments, given by way of non-limiting indication, with reference to the accompanying drawings, in which:

FIG. 1 shows six examples of spectrograms with the identification of different types or categories of noise recognizable by the method according to the invention;

FIG. 2 shows a further example of a spectrogram with the identification of an additional noise category, recognizable by the method according to the invention;

FIGS. 3 and 4 are simplified block diagrams, which illustrate some steps comprised in an embodiment of the method;

FIGS. 5-7 show examples of spectrograms used in embodiments of the method;

FIG. 8 shows a spectrogram in which a tagging operation was performed;

FIG. 9 shows a block chart, which illustrates an embodiment of the method according to the invention;

FIG. 10 shows four precision-recall diagrams related to four different types of noise recognizable by the method;

FIG. 11 shows a simplified block diagram of a system capable of performing the method according to the invention.

### DETAILED DESCRIPTION

A method for identifying and characterizing noises generated by a vehicle braking system is described.

The method first comprises the steps of detecting noises generated by a vehicle braking system under dynamic operating conditions and generating digital audio data representative of the detected noise.

The method then provides analyzing the aforesaid digital audio data by a noise analyzer, to identify potential squeal events and the respective likely squeal frequencies, and generating squeal frequency information indicative of the squeal frequencies of the identified potential squeal events.

The method then comprises the steps of filtering the aforesaid digital audio data by means of high-pass filtering to eliminate spectral components at frequencies lower than a filtering frequency, to generate filtered digital audio data; and generating, based on the filtered digital audio data, a respective spectrogram, which represents, in graphical form, information present in the filtered digital audio data, comprising the sound signal intensity, as a function of time and frequency.

The method then involves providing the aforesaid spectrogram and the aforesaid squeal frequency information to a trained algorithm, wherein the algorithm was trained using artificial intelligence and/or machine learning techniques.

The method also provides identifying noise events, by the trained algorithm, based on the above spectrogram and squeal frequency information, classifying the identified noise events and finally providing information about the identified noise events, each characterized by the respective category.

The aforesaid classification step involves a classification according to at least the following categories: a first category comprising noises to be detected generated by the characteristic dynamic operation of the braking system; and a second category comprising abnormal noises, generated by operational or test anomalies.

According to an embodiment of the method, the aforesaid categories in which the noises are classified further comprise a third category comprising higher-order harmonics not deriving from physically generated noises.

According to an embodiment, the aforesaid first category of noises comprises squeal noises and/or chirp/wirebrush noises and/or artifacts, i.e., noises having wide bandwidth in frequency and high intensity.

According to an implementation option of the aforesaid embodiment, the step of classifying the identified noise events further comprises recognizing and further classifying the noises in the first category as belonging to one of the following sub-categories: squeal noises, chirp/wirebrush noises, artifacts.

According to an embodiment of the method, the aforesaid step of classifying the identified noise events further comprises recognizing and further classifying the noises in the second category as belonging to one of the following sub-categories: abnormal noise due to imperfections of the experimental bench (“bench noise”), or noises due to collisions (“clang noise”) between brake system components.

According to an embodiment of the method, the dynamic operating conditions of the braking system from which the noises are derived are test conditions, wherein a sequence of predefined test braking events characterized by predefined parameters is applied to the braking system, said predefined parameters comprising at least a predefined rotational speed and/or a predefined braking pressure.

In this case, the steps of the method, shown above, are performed at each test braking event.

According to an embodiment of the method, the aforesaid trained algorithm is an algorithm trained by means of a preliminary step of training, based on a training dataset comprising spectrograms corresponding to known conditions and characterized according to the aforesaid classification of noise into categories and/or sub-categories, desired as a result of the analysis. In this case, the aforesaid spectrograms of the training dataset and further information about the known classification of each noise event are provided as input to the algorithm to be trained.

According to an implementation option, the aforesaid step of preliminary training comprises: tagging or labeling the known noise events present in each of the training spectrograms; and then calibrating the parameters of the algorithm to be trained based on the training spectrograms processed by tagging or labeling.

According to an implementation example, the spectrograms are not altered during the “tagging” process, which instead involves the generation of additional “accompanying” data.

According to an implementation option, the aforesaid step of tagging or labeling is performed manually by drawing a rectangle on a pattern of the training spectrogram identified as a noise event and associating the rectangle with a label indicating the category and/or sub-category of the noise event, referred to the aforesaid classification.

According to another implementation option, the aforesaid step of tagging or labeling is carried out with the support of an enabling software (such as “labellmg”).

According to another implementation option, the aforesaid step of tagging or labeling is supported by listening to an audio file representative of the detected noise.

According to an implementation option, the method comprises the further step of verifying the predictive capabilities of the trained algorithm on an additional dataset of tagged validation spectrograms.

According to an embodiment of the method, the aforesaid trained algorithm is a machine learning algorithm based on neural networks.

According to possible options of implementation, the aforesaid neural networks comprise deep neural networks, or convolutional neural networks, or zoned convolutional neural networks or Region-Based Convolutional Neural Networks.

According to another embodiment of the method, the aforesaid trained algorithm is a machine learning algorithm based on Deep Object Detectors or Two-Stage Deep Object Detectors.

According to an embodiment, the method comprises, in addition to the step of generating a spectrogram, the further step of generating a segmented spectrogram, in which the points are graphically highlighted in dependence of an intensity band to which they belong, within a plurality of intensity bands delimited by respective predetermined thresholds.

In this case, the spectrogram is provided to the trained algorithm as an additional input, in addition to the unsegmented spectrogram and information on probable squeal frequencies.

According to an implementation option, the aforesaid intensity bands, for which points are highlighted in a respective manner, comprise a high-intensity band, inferiorly delimited by a first threshold, a medium-intensity band, between the first threshold and a second threshold, below the first threshold, and a low-intensity band, below the second threshold.

According to a particular example of implementation, the first threshold is set at 50 dB, and the second threshold is set at 30 dB.

According to an embodiment of the method, the aforesaid step of generating digital audio data representative of the detected noise comprises generating files and/or audio tracks acquired while performing the test on the braking system.

According to a particular example of implementation, audio tracks are in .wav or mpeg format.

According to an embodiment of the method, the aforesaid step of analyzing digital audio data comprises: identifying noise events, and among them the squeal events, based on criteria associated with the intensity or amplitude and/or based on criteria associated with frequency by means of spectral methods, such as the Fourier transform; then generating, by the noise analyzer, a first data file in tabular form in which there are recorded all the potential squeal events identified by the noise analyzer and, for each squeal event, the time instant in which it occurred, the duration, the respective squeal frequency, the maximum and/or average sound pressure and/or amplitude and/or sound intensity of the time instant.

In this case, the aforesaid squeal frequency information is obtained by the aforesaid first data file in tabular form.

According to an implementation option, the aforesaid filtering frequency, in the step of filtering the digital audio data by high-pass filtering, is 500 Hz.

According to an embodiment of the method, the aforesaid step of providing information about the identified squeal events comprises generating, based on the results of the processing by trained algorithm, a second data file in tabular form in which there are recorded all the squeal events identified by the trained algorithm and, for each squeal event, the time instant in which it occurred, the duration, the respective squeal frequency, the maximum and/or average sound pressure and/or amplitude and/or sound intensity of the time instant.

According to an option of implementation of the method, the aforesaid second data file in tabular form is a refinement of the aforesaid first data file in tabular form, in which all false positives deriving from the events recognized as belonging to the third category, comprising higher-order harmonics, and/or all events recognized as belonging to the second category, comprising noise deriving from anomalies, are removed.

According to an embodiment of the method, when a noise event belonging to third category is identified, the method comprises the further step of generating a warning and/or alarm signal associated with the identified third category noise event.

According to an implementation option, if the identified noise event belongs to the abnormal noise sub-category due to imperfections of the test bench, the further step of stopping the current test and verifying the text bench is comprised.

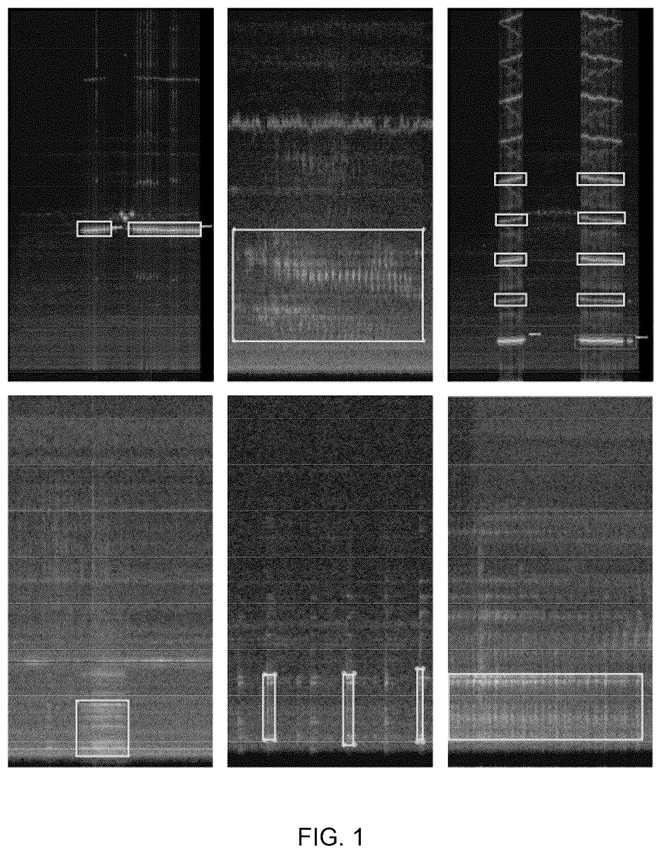

Further details of the method will be given below, referring to FIGS. 1-11, for illustrative and non-limiting purposes only, according to a particular embodiment of the invention.

In this example, the noise generation is measured during the steps of development of a brake system by testing on a dynamometric test bench; during the dynamometric testing, a predefined braking sequence is applied in terms of operating parameters, such as rotational speed and braking pressure.

The noise is measured during the test by means of a noise analyzer, known in itself, installed on the bench itself.

A standard noise analyzer, configured to identify noise events based on amplitude criteria and/or spectral methods involving Fourier transforms, can be employed for this purpose. The output provided by the noise analyzer is a tabular data file, in which, for each braking event tested, relevant data inherent in the squeal events detected are listed, i.e., instant in time, frequency, maximum and average sound pressure, duration, and so on.

The data file may contain errors in the form of false positives.

In order to improve the measurement and/or detection quality, the frequency values associated with false positives must be removed.

In this regard, in the present invention, and in particular in the example of the embodiment described herein, artificial intelligence, AI, techniques are employed to check/verify all noise events recorded by the noise analyzer during a test and correct the original file (for example, by removing false positive), thereby enabling more reliable, repeatable and objective test results.

For example, “transfer learning” training techniques are employed to construct machine-learning algorithms, ML, i.e., for example, an algorithm pre-trained on another dataset.

As a further exemplification, with respect to the algorithms already mentioned above, it is worth noting that ML algorithms, known in themselves, can be used, including, for example, the “Mask-RCNN” model, based on neural networks (NN), which are, for example, trained using an open-source COCO dataset as the training dataset.

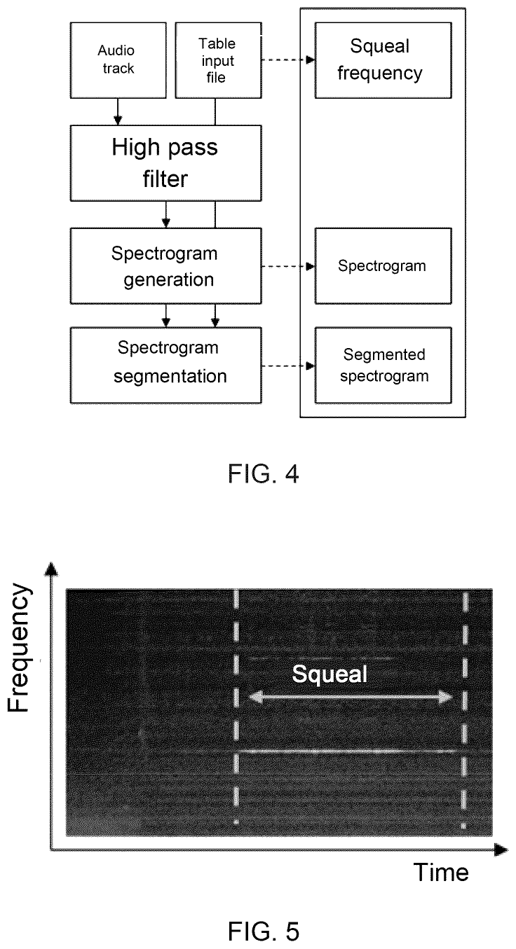

A typical flowchart of an ML algorithm involves the steps shown in FIG. 3: input preparation, tagging, and model training.

These steps are carried out, in the present invention, with peculiar features, especially concerning input preparation and tagging, to achieve improvements over the prior art, leading to an enriched/improved model of AI-based noise detection.

The step of input preparation comprises all the operations aimed at processing the numerical information contained in the output tabular file (provided by the noise analyzer) to obtain digital information suitable to be more effectively provided as input to an ML algorithm, e.g., a “deep learning” model.

This is achieved, in the embodiment described here, by a series of steps, as illustrated for example in FIG. 4, and in particular by appropriately transforming sound data into digital images, which are more suitable for use as input to the ML algorithm.

Firstly, a high-pass filter is applied to each detected audio track to eliminate background noise at low frequencies (e.g., <500 Hz), which could lead to a bias or shift in the color scale of the obtained digital image (also called a “spectrogram”) which can have deleterious effects in subsequent processing steps.

From audio data manipulated as indicated above, a spectrogram, i.e., a graph of frequency as a function of time, colored according to the local intensity of the sound signal, is then generated for each braking event for each time-frequency point on the graph.

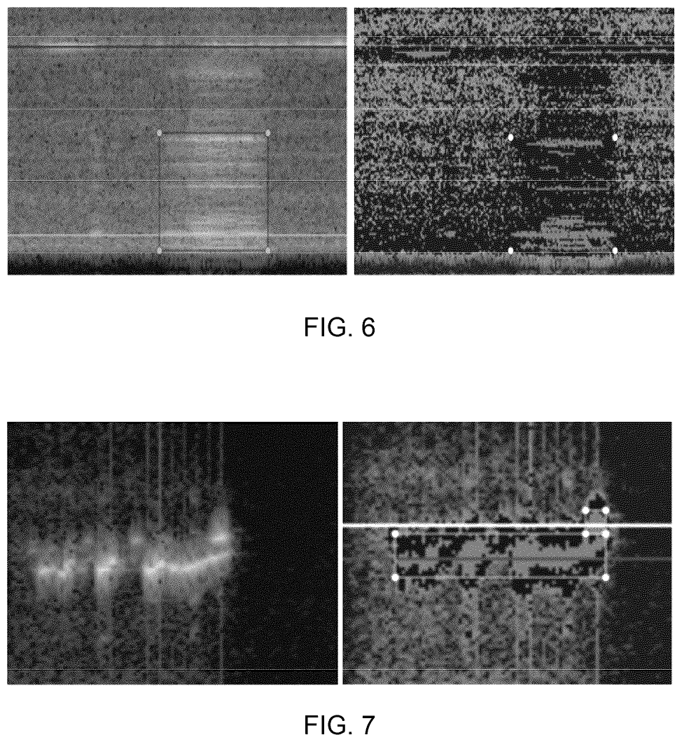

The spectrogram is shown in FIG. 5, for example.

According to an implementation option, to make the image more readable, an additional operation is performed, to highlight high and medium-intensity points, on the spectrogram, and make them stand out better from the background:
all points with intensity greater than 50 dB (high intensity) are colored with a vivid first color (e.g., pink);
all points with higher intensity between 30 dB and 50 dB (medium intensity) are colored with a second vivid color (e.g., dark red).

This is shown in FIG. 6, which depicts a spectrogram before segmentation (left) and after segmentation (right). The pink and dark red are rendered in FIG. 6 with respective lighter gray tones, compared to the background.

By setting the above two thresholds, two ranges in intensity are defined and displayed, representing an additional level of information (for the ML algorithm) about what the user considers important or not.

According to other implementation options, a plurality (thus any number greater than 2) of intensity segmentation intervals is defined by setting a plurality of respective thresholds, having defined a plurality of thresholds.

With reference to the step of “tagging” or labeling, according to an implementation option, it involves manual tagging of spectrograms. This step of “tagging” involves identifying predefined categories of sounds in the images (spectrograms). Accurate tagging of training images is an important pre-condition for achieving effective operation of the trained algorithm (e.g., “deep learning”).

In this example, the noise categories considered are as follows (already mentioned and illustrated above):
squeal, chirp/wirebrush, artifact;
higher order harmonics;
bench noise (i.e., abnormal noise indicating poor experimental arrangement);
clang noise, which indicates problems in the design of the brake system.

How these categories appear in the spectrograms is depicted in FIG. 1: squeals in the upper left spectrogram, wirebrush in the upper center spectrogram, squeals with higher order harmonics in the upper right spectrogram, noise artifact in the lower left spectrogram, clang noise in the lower center spectrogram, and test bench noise in the lower right spectrogram.

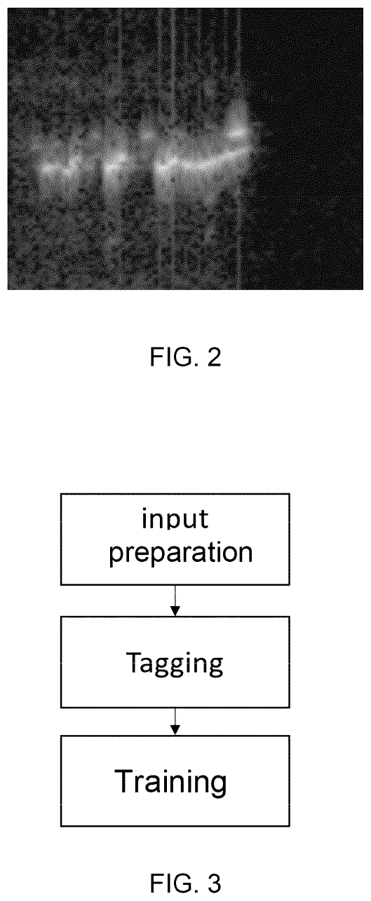

A single-frequency squeal with variations in intensity is shown in FIG. 2.

FIG. 5 shows a squeal in a spectrogram, with advantageous highlights.

The “tagging” operation is carried out, for example, by drawing a rectangle in the image and associating each rectangle with a respective label indicating one of the aforementioned noise categories.

According to a particular implementation option, the step of “tagging” is supported by facilitating/enabling software, such as the previously mentioned open-source tool “labellmg”, which adds a few features.
(i) Firstly, the user can switch between a normal color spectrogram and a segmented spectrogram, depending on the type of coloring scheme which allows easier recognition of a given pattern on the image. Furthermore, the color segmentation facilitates the definition of shared rules for tagging noise events in images, thus making the process more objective and repeatable. For example, in the case of a single-frequency squeal with variation in intensity, the two thresholds defined for spectrogram segmentation make it possible to establish shared and unambiguous rules for determining whether the event being analyzed consists of a single squeal or a plurality of squeals, which are close to each other but distinct (see, for example, FIG. 7, which shows the same single-frequency squeal situation on a spectrogram without segmentation, on the left, and on a spectrogram with segmentation, on the right).
(ii) In addition, a further option of the implementation of the method involves the possibility of displaying the frequencies at which the noise analyzer recorded each squeal on the spectrogram. In the spectrogram coordinates, these frequency values correspond to horizontal lines drawn at different heights.
(iii) Moreover, a further option of implementation of the method provides the ability to listen to the audio track corresponding to the displayed spectrogram; thus, the audio supports the visual pattern recognition.

The aforesaid three options, especially when all of them are employed, help to increase the quality of tagging, and thus both the training and the full performance of the algorithm.

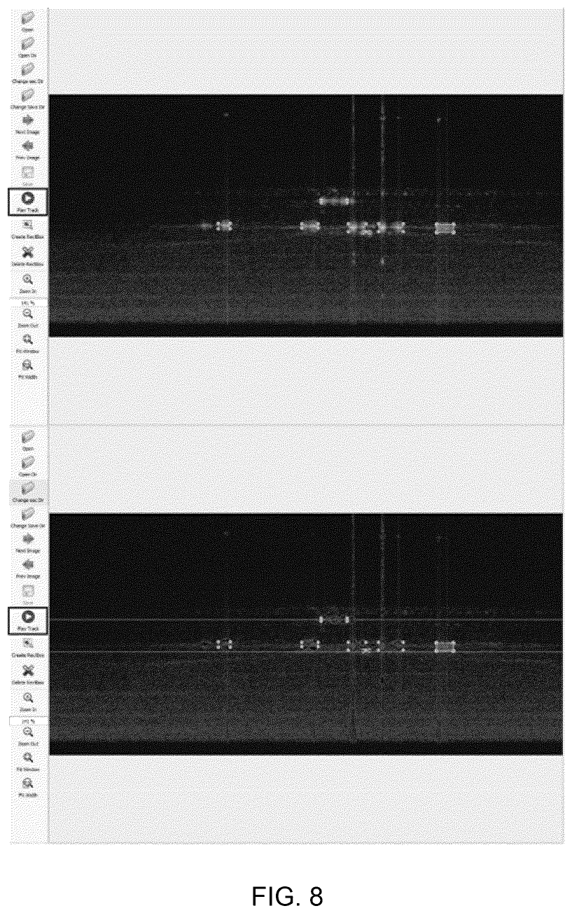

Reference is now made to FIG. 8, which shows a graphical user interface (GUI) of the “labellmg” tagging tool enhanced with the above features (i), (ii), (iii).

The step of tagging is followed by a training process, which in the example considered here is carried out in the following manner: a subset of the dataset on which the “tagging” was done (consisting of 1017 audio files) is provided as input to the AI algorithm to calibrate the model parameters and make them suitable for making predictions. For each braking event, the tagging-enriched data provided to the algorithm comprise three interrelated entities (as shown in FIG. 4): the spectrogram, the segmented spectrogram, and the set of frequencies at which the noise analyzer identified the squeals (the latter information can be extracted directly from the noise analyzer and included in its tabular output file).

In the embodiment described here, after the algorithm has been trained, its predictive capabilities are tested on another dataset of the same nature. When the algorithm identifies a noise other than a squeal (or no noise) with a confidence level that exceeds a certain preset threshold, a false positive emerges, i.e., an event recognized by the noise analyzer as a squeal, but which in fact is not.

At this point, the algorithm transfers the identified spectrogram information into the time, frequency, and intensity domains, and deletes the event under analysis from the initial file.

Once this processing is completed, the output file has the same header and structure as the original tabular file, but metrics related to squeals that have been recognized by the artificial intelligence, AI, as false positives are removed.

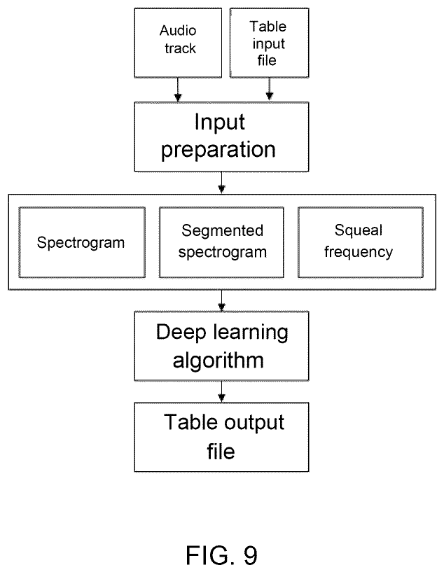

The overall flow chart of the aforesaid embodiment is shown in FIG. 9.

When a noise event is recognized as clang noise or test bench noise, during a test, according to an implementation option the method not only removes the corresponding frequency value from the tabular file but also issues a warning that there are noises that may be associated with anomalies that are potentially detrimental to the entire test.

If the test bench noise is identified and the test in which that noise was identified is still in progress, the operator may decide to stop the test or pause it, to allow for verification that the experimental bench is properly installed.

If the ML algorithm is run after the end of a test in which at least one test bench noise or collision noise has been reported, this information may prove particularly useful because it alerts the operator to unexpected or atypical results obtained during the analyzed test session.

In the implementation example described here, the tests were performed on the subset of datasets with complementary tagging to the subset employed during training.

The dataset test consisted of 270 audio files with a total of 683 squeal events, 29 chirp/wirebrush events, 20 clang noise events, and 42 noise artifact events.

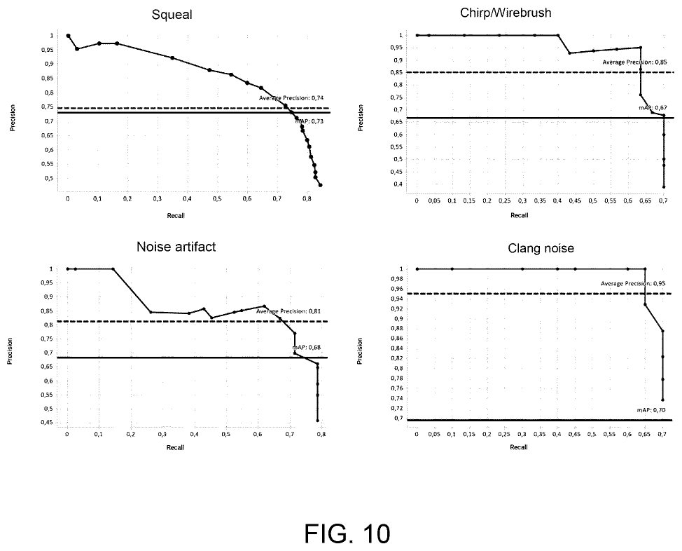

Precision-recall diagrams for the object detection task are depicted in FIG. 10 along with the corresponding mean precision (mAP) and accuracy over all the values of the recall curve (AP). The four diagrams in FIG. 10 refer to squeal in the upper left, chirp/wirebrush in the upper right, noise artifact in the lower left, and clang noise in the lower right. The intersection on union (IoU) used to determine matches between reality and prediction was set to 0.5.

With these performance levels and the addition of specific post-processing logic (e.g., removal of squeal harmonics at multiple frequencies according to integer numbers of the lowest frequency detected in the same time interval), it has been shown that the occurrence of false squeals can be reduced by 30% (from 35% to 5%) by introducing 4% of erroneous removals from the total number of proposed removals (i.e., increasing the false negative rate from 0% to 2%).

The removal of noises other than squeal is carried out in parallel during the dynamometric tests.

During the test, the audio files are recorded and saved when the occurrence of one or more squeals is recorded by the base system.

According to an implementation option, audio files and a partial squeal detection report are therefore sent to a centralized server for analysis. A squeal detection report is produced, in which false occurrences of squeals identified by the AI system were filtered out. This report, along with alerts regarding anomalies (i.e., the presence of bench noise or clang noise) are made available in a centralized repository.

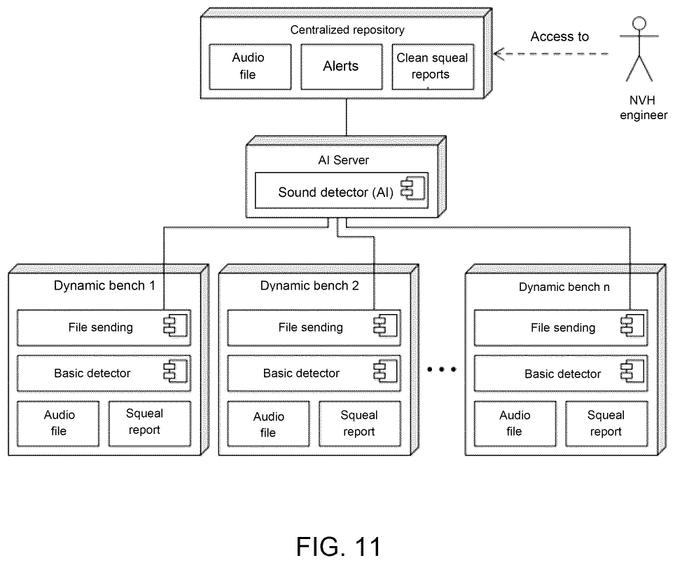

An embodiment of a system capable of implementing the above method, according to the invention, is shown in FIG. 11.

The components of the system illustrated in FIG. 11 are N dynamometric (or roller stand) test benches (in each of which audio files, a squeal report, a basic detector, and a file-sending block are shown), all connected to a centralized artificial intelligence (AI) server comprising a “noise detector” block, in which the machine-learning algorithm operates, which in turn is connected to a central repository, in which audio files, warnings/alerts, and corrected reports on the occurrence of squeals are stored.

As can be seen, the objects of the present invention as previously indicated are fully achieved by the method described above by virtue of the features disclosed above in detail. The advantages and technical problems solved by the method according to the invention were mentioned above, with reference to the various features and aspects of the method.

In order to meet contingent needs, those skilled in the art may make changes and adaptations to the embodiments of the method described above or can replace elements with others which are functionally equivalent, without departing from the scope of the following claims. All the features described above as belonging to a possible embodiment may be implemented irrespective of the other embodiments described.

1-20. (canceled)

21. A method for identifying and characterizing noises generated by a vehicle braking system, comprising the steps of:
detecting noises generated by a vehicle braking system under dynamic operating conditions;
generating digital audio data representative of the detected noise;
analyzing said digital audio data by a noise analyzer, to identify potential squeal events and the respective likely squeal frequencies, and generating squeal frequency information indicative of the squeal frequencies of the identified potential squeal events;
filtering said digital audio data by means of high-pass filtering to eliminate spectral components at frequencies lower than a filtering frequency, to generate filtered digital audio data;
generating, based on said filtered digital audio data, a respective spectrogram, which represents, in graphical form, information present in the filtered digital audio data, comprising the sound signal intensity, as a function of time and frequency;
providing said spectrogram and said squeal frequency information to a trained algorithm, wherein the algorithm was trained using artificial intelligence and/or machine learning techniques;
identifying noise events, by said trained algorithm, based on said spectrogram and said squeal frequency information, and classifying the identified noise events according to at least the following categories:
a first category comprising noises to be detected generated by the characteristic dynamic operation of the braking system;
a second category comprising abnormal noises, generated by operational anomalies or test anomalies;
providing information about the identified noise events, each characterized by the respective category.

22. A method according to claim 21, wherein said categories in which the noises are classified further comprise a third category comprising higher-order harmonics not deriving from physically generated noises.

23. A method according to claim 21, wherein said first category of noises comprises squeal noises and/or chirp/wirebrush noises and/or artifacts, i.e., noises having broad bandwidth in frequency and high intensity.

24. A method according to claim 23, wherein said step of classifying the identified noise events further comprises:
recognizing and further classifying noises in the first category as belonging to one of the following sub-categories: squeal noises, chirp/wirebrush noises, artifacts.

25. A method according to claim 21, wherein said step of classifying the identified noise events further comprises:
recognizing and further classifying the noises of the second category as belonging to one of the sub-categories: abnormal noise due to imperfections of the test bench, or noises due to collisions between components of the braking system.

26. A method according to claim 21, wherein the dynamic operating conditions of the braking system from which the noises are derived are test conditions, wherein a sequence of predefined test braking events characterized by predefined parameters is applied to the braking system, said predefined parameters comprising at least a predefined rotational speed and/or a predefined braking pressure,
wherein the steps of the method of claim 21 are performed at each test braking event.

27. A method according to claim 21, wherein said trained algorithm is an algorithm trained by means of a preliminary step of training, based on a training dataset comprising spectrograms corresponding to known conditions and characterized according to said classification of noise into categories and/or sub-categories, desired as a result of the analysis,
wherein said spectrograms of the training dataset and information about the known classification of each noise event are provided as input to the algorithm to be trained.

28. A method according to claim 27, wherein said step of preliminary training comprises:
tagging or labeling of the known noise events present in each of the training spectrograms;
calibrating the parameters of the algorithm to be trained based on the training spectrograms processed by tagging or labeling.

29. A method according to claim 28, wherein said step of tagging or labeling is performed manually by drawing a rectangle on a pattern of the training spectrogram identified as a noise event and associating said rectangle with a label indicating the category and/or sub-category of the noise event, referred to said classification,
wherein said step of tagging or labeling is performed with the support of enabling software,
or wherein said step of tagging or labeling is supported by listening to an audio file representative of the detected noise.

30. A method according to claim 27, comprising the further step of:
verifying the predictive capabilities of the trained algorithm on an additional dataset of tagged validation spectrograms.

31. A method according to claim 27, wherein said trained algorithm is a neural-network-based machine learning algorithm,
wherein said neural networks comprise deep neural networks, or convolutional neural networks, or zoned convolutional neural networks or Region-Based Convolutional Neural Networks.

32. A method according to claim 27, wherein said trained algorithm is a machine learning algorithm based on Deep Object Detectors or Two-stage Deep Object Detectors.

33. A method according to claim 21, comprising, in addition to the step of generating a spectrogram, the further step of generating a segmented spectrogram, in which the points are graphically highlighted in dependence of an intensity band to which they belong, within a plurality of intensity bands delimited by respective predetermined thresholds;
and wherein said segmented spectrogram is provided to the trained algorithm as an additional input, in addition to the unsegmented spectrogram and information of probable squeal frequencies.

34. A method according to claim 33, wherein said intensity bands, for which points are highlighted in a respective manner, comprise a high-intensity band, inferiorly delimited by a first threshold, a medium-intensity band, between said first threshold and a second threshold, below said first threshold, and a low-intensity band, below said second threshold.

35. A method according to claim 21, wherein said step of generating digital audio data representative of the detected noise comprises generating files and/or audio tracks acquired while performing the test on the braking system.

36. A method according to claim 21, wherein the step of analyzing the audio digital data comprises:
identifying noise events, and among them the squeal events, based on criteria associated with the intensity or amplitude and/or based on criteria associated with frequency by means of spectral methods, such as the Fourier transform;
generating, by the noise analyzer, a first data file in tabular form in which there are recorded all the potential squeal events identified by the noise analyzer and, for each squeal event, the time instant in which it occurred, the duration, the respective squeal frequency, the maximum and/or average sound pressure and/or amplitude and/or sound intensity in the time instant;
and wherein said squeal frequency information is obtained from said first data file in tabular form.

37. A method according to claim 21, wherein said filtering frequency, in the step of filtering the digital audio data by high-pass filtering, is 500 Hz.

38. A method according to claim 21, wherein said step of providing information about the identified squeal events comprises generating, based on the results of the processing by trained algorithm, a second data file in tabular form in which there are recorded all the squeal events identified by the trained algorithm and, for each squeal event, the time instant in which it occurred, the duration, the respective squeal frequency, the maximum and/or average sound pressure and/or amplitude and/or sound intensity in the time instant,
wherein said second data file in tabular form is a refinement of said first data file in tabular form, wherein all false positives deriving from the events recognized as belonging to the third category, comprising higher-order harmonics, and/or all events recognized as belonging to the second category, comprising noise deriving from anomalies, are removed.

39. A method according to claim 21, wherein when a noise event belonging to the second category is identified, the method comprises the further step of generating a warning and/or alarm signal associated with the identified second category noise event.

40. A method according to claim 39, wherein, if the identified noise event belongs to the sub-category abnormal noise due to imperfections of the test bench, the further step of stopping the current test and verifying the text bench is comprised.
